(19) United States
(12) Patent Application Publication
(10) Pub. No.: US 2005/0243025 A1
(43) Pub. Date: Nov. 3, 2005

(54) Matrix display including inverse transform decoding and method of driving such a matrix display

(75) Inventors: David A. Fish, Haywards Heath (GB); Cornelis Van Berkel, Hove (GB)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V., BA Eindhoven (NL)

(21) Appl. No.: 10/520,328

(22) PCT Filed: Jun. 25, 2003
(86) PCT No.: PCT/IB03/02882

§ 371 Date: Jan. 4, 2005

(30) Foreign Application Priority Data
Jul. 6, 2002 (GB) 0215721.2

(51) Int. Cl. G09G 3/20

(52) U.S. Cl. 345/55

(57) ABSTRACT

A display component includes in each pixel of a block a summing element, such as a capacitor (26), current source (22) and current sink (32), and switches (24,34) connecting the current source and sink to the summing element (32). Basis functions are supplied to basis function inputs (42, 44) to control the switches (24,34) in accordance with the basis functions. The current source (22) and sink (32) of the pixels of the block are modulated in common in accordance with an input data stream. Decoded transform data is accumulated on capacitor (26), the display output being determined by the accumulated voltage. The individual pixels are thus able to carry out a data decoding operation.

The invention relates to a display and to a method of driving a display using data coded using a transform.

Matrix type displays include for example liquid crystal displays and arrays of light emitting diodes. Such displays can be used in a wide variety of applications, including in particular television screens, computer monitors and many more.

As display resolution increases the rate at which data needs to be transferred to the display increases likewise. This consumes greater power and causes electromagnetic interference problems.

A variety of coding schemes have been used to code data for display. Although these may be beneficial in avoiding the need to transmit large quantities of data over long distances, the coded data still needs to be decoded in a decoder before being used to drive the display. Thus, there is still a large amount of data transmitted between the decoder and the display.

According to the invention, there is provided a display component for decoding and displaying data coded using a transform having basis functions. The display component includes a plurality of pixels arranged as a block; each pixel including: a summing element; a first element providing a unit positive contribution to the summing element; a first switch connecting the first element to the summing element; a second element providing a unit negative contribution to the summing element; a second switch connecting the second element to the summing element; control circuitry connected to the first and second switches for switching the first and second switches in accordance with basis function values; wherein each block comprises a modulator for modulating all the first and second elements of the pixels of the block in common in accordance with input data, so that the summing element accumulates decoded input data for display in accordance with the input data and the basis function values.

The display component according to the invention can cope with and decode coded data internally. Thus, the display component according to the invention can reduce the number of decoder ICs required in an implementation of a display and may at the same time reduce data rates that need to be delivered to the display.

The need to supply reduced data rates to the display can provide a number of benefits including reductions in electromagnetic interference and/or improved power consumption.

Each pixel uses a capacitance to accumulate the decoded data. The capacitance may include a discrete capacitor and/or a part of the pixel having additionally another function such as an electrode of a liquid crystal display (LCD).

The display component may be for example the active plate of a liquid crystal display, which combines to make a display with a passive plate, the active and passive plates sandwiching liquid crystal. The display component may also be a functioning display in its entirety; for example an active matrix polymer light emitting diode (AMPLED) display or other active matrix organic light emitting diode (AMOLED) display.

In embodiments, the summing element is a capacitance, the voltage on the capacitance determining the pixel output; the first element is a modulated current source for charging the capacitance, and the second element is a modulated current sink for discharging the capacitance.

The display preferably includes a basis function generator for generating a sequence of basis function values in accordance with the basis functions or the inverse basis functions, the basis function generator being connected to the pixels of the block to control the switches of each pixel.

The current source may be implemented by a photodiode connected between a high voltage rail and the capacitor, and the current sink by a photodiode connected between a low voltage rail and the capacitor. The modulator may include a light emitting element arranged to transmit an optical signal to the photodiodes of the block to modulate the photodiodes. Thus, in this arrangement the modulation of the current sources and sinks is carried out using an optical signal supplied in parallel by the light emitting element to all elements of the block.

The use of a light emitting element, which may be an LED, to transmit signals to the photodiodes operating as current source and sink allows the modulation of each element of the block in common without the need for excessive additional wiring.

Alternatively, the current sources and sinks may be transistors having control terminals connected through common data lines to the modulator. In this arrangement, the modulation of the current sources and sinks is carried out using an electrical signal.

The display may have a plurality of blocks arranged in rows and columns, each row of blocks having a block select line for selecting that row of blocks, and the pixel elements of each row of blocks only operate to decode data when selected by the block select line. This allows the data for the rows of blocks to be delivered sequentially. This approach may be adopted whether or not the current sources and sinks are modulated optically or electrically.

To implement selection of blocks, each pixel of each block may have a block select switch connected between the capacitor and the first and second switches, the block select switch being connected to a block select line.

In order to reset the display, each pixel is preferably provided with a reset transistor, for example a FET with its source and drain connected between the capacitance and one of a high voltage rail and its low voltage rail and gate connected to the other of the high and low voltage rails.

It might be thought that it would be difficult to get a basis function signal to each element of a two dimensional block to switch each element sequentially in accordance with basis functions that are in general different for each element. However, the inventors have realised that it is possible to implement the display by providing the control circuitry of each pixel with row and column basis function inputs.

The display may accordingly include row basis function lines connected to the row basis function input of each pixel element of a row of pixel elements of a block; column basis function lines connected to the column basis function input of each pixel element of a column of pixel elements of a block; and at least one basis function generator for generating basis functions for each row and column and outputting the basis functions on respective outputs of the at least one basis function generator connected to respective row and column basis function lines.

Thus, the row basis functions are generated for each element of a row and the column basis functions for each element of a column. Different row and column basis functions and hence different sequences are generated for each distinct row and column.

The row and column basis function values may be combined in each pixel by providing each pixel with an XOR gate having the XOR gate inputs connected to the first and second basis function inputs and the XOR gate output connected to one of the first and second switches directly and the other of the first and second switches through an inverter.

Preferably the basis functions are cosine or Walsh basis functions which take only two values, typically represented as +1 or −1.

The invention also relates to a method of driving a display having a plurality of a plurality of pixels arranged as a block, each pixel including a summing element, a current source, a current sink, and switches connecting the current source and sink to the capacitance, the method including:

accepting an input data stream for the block including a plurality of sequential data items coded using a transform having basis functions; modulating the current source and the current sink in common for all pixels of the block in accordance with the input data stream;

switching the switches in each pixel between a state in which the current source or sink is connected to the capacitance to charge or discharge the capacitance and a state in which the current source or sink is not connected, the switching taking place sequentially in accordance with a sequence of basis function values for each pixel of the block determined by the location of each pixel within the block; and

displaying a visual output for each pixel in accordance with the charge stored on the capacitance.

For a better understanding of the invention, embodiments will now be described, purely by way of example, with reference to the accompanying drawings, in which:

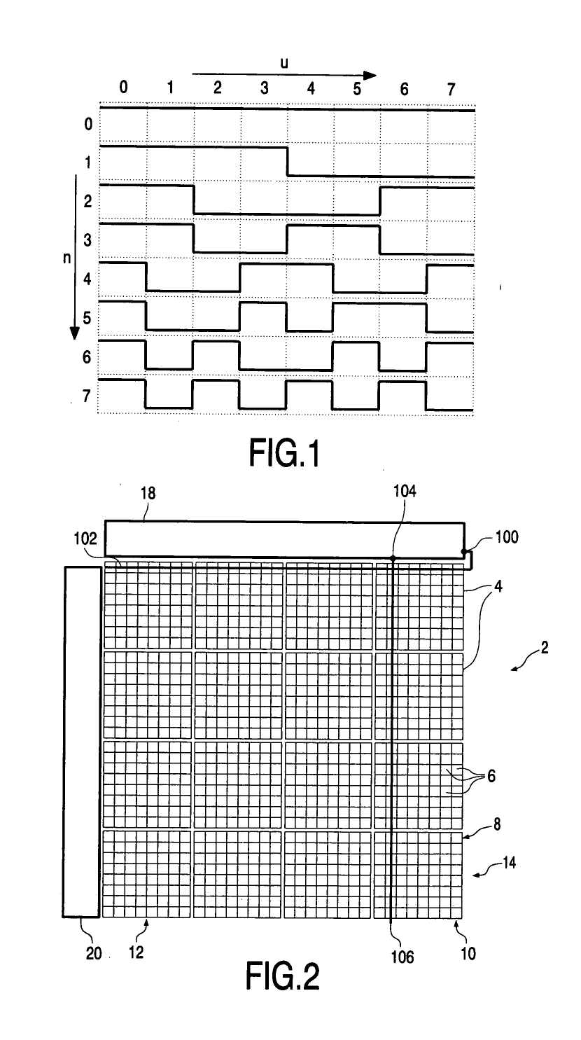

FIG. 1 illustrates Walsh basis functions.

FIG. 2 shows a general implementation of an embodiment of a display component according to the invention;

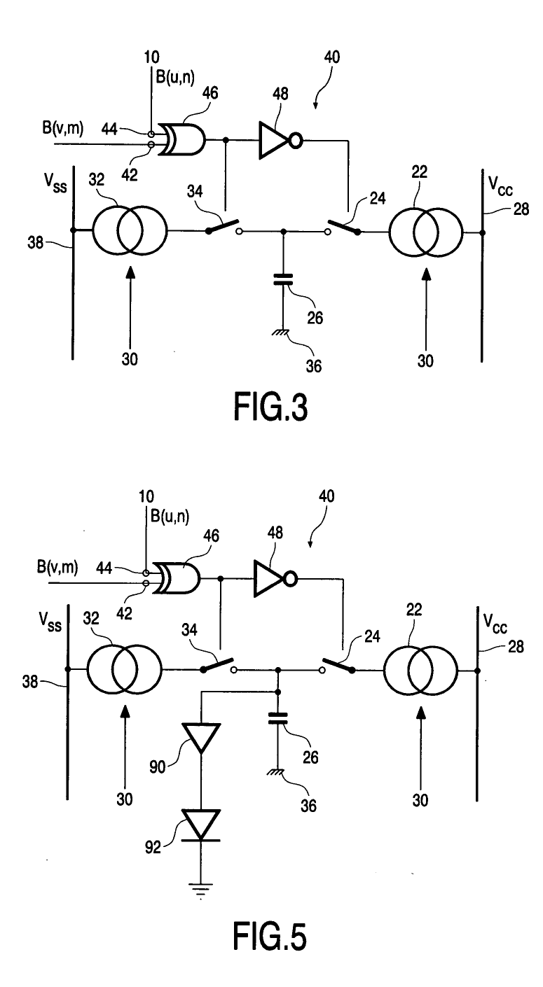

FIG. 3 shows a general implementation of a pixel;

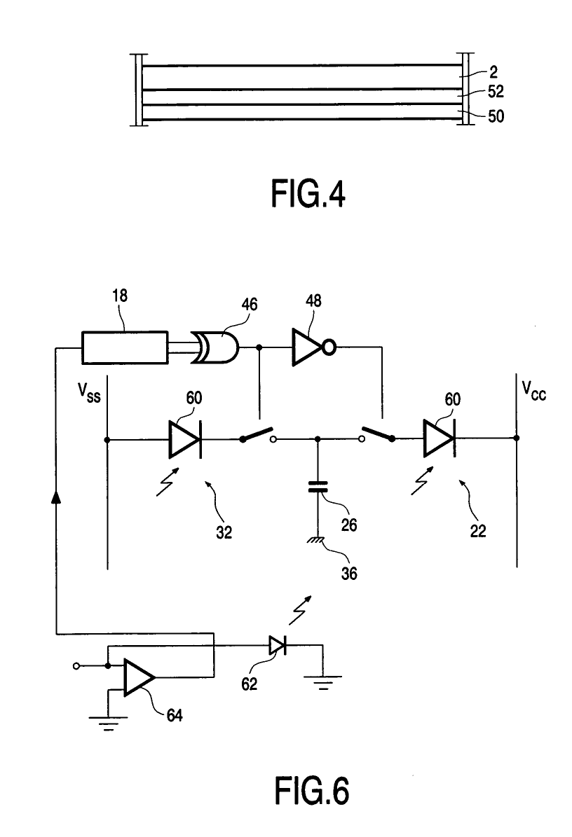

FIG. 4 illustrates an embodiment of an LCD using the display component according to FIG. 3;

FIG. 5 illustrates an alternative embodiment of an active matrix polymer light emitting diode pixel;

FIG. 6 illustrates a pixel implementation according to a specific embodiment of the invention using optical addressing;

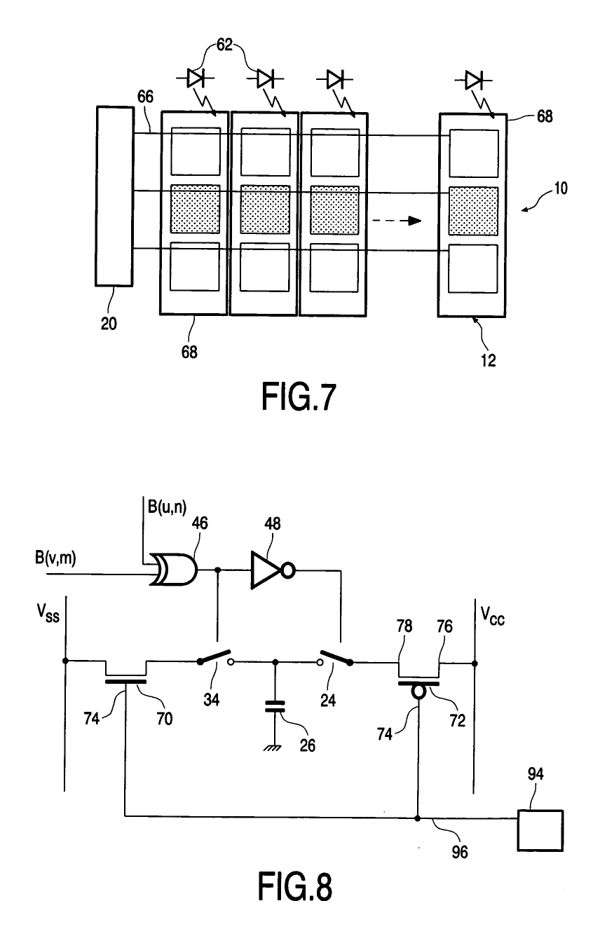

FIG. 7 illustrates a further specific embodiment using optical addressing of rows of blocks;

FIG. 8 illustrates a still further specific embodiment of the invention using electrical addressing; and

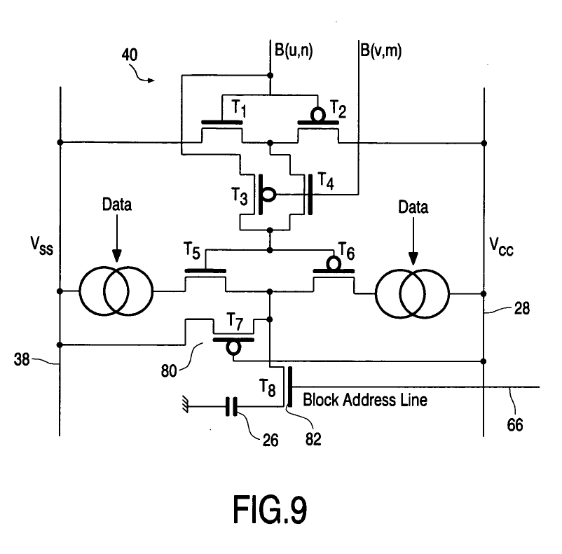

FIG. 9 illustrates a detailed circuit diagram of a pixel of the embodiment of FIG. 8.

It should be understood that the Figures are merely all schematic. The same reference numbers and signs are used throughout the Figures to denote the same or similar parts.

Methods of encoding data using basis functions are well known, and include the Cosine and Walsh transform both of which are well known to those skilled in the art of data compression. The cosine transform in particular is used in the widely adopted image data coding schemes known as JPEG and MPEG. For completeness, the inverse transform which is required to decode images coded in this way will now be discussed.

It should be noted that the terms “basis function” and “basis function value” are used in this specification to include the basis functions for the inverse transform and inverse basis function values for the inverse transform. Indeed, for many transforms such as the Walsh transforms the basis functions for the inverse transform are the same as those for the forward transform.

The use of data encoded in JPEG and MPEG formats is becoming ever wider. A display that can deal with this data would have benefits in terms of reducing the number of decoder ICs required and at the same time would reduce data rates all the way to the display pixel giving EMI reductions. Reductions in power consumption are likely to be a further benefit. In an embodiment of the invention an active matrix display is provided with a data decoding capability for blocks of pixels where the blocks of data are encoded with a suitable transform (e.g. cosine or Walsh). This proposal is intended the cover the concept of block based transform decoding on any display type implemented using current addition techniques. Two particular embodiments will be described, including the transistor level design appropriate for a reflective LCD display in a mobile application. The use of these implementations in emissive displays such as an AMPLED is also envisaged.

No consideration of the encoding of the data is given here, since appropriate coding methods are well known to those skilled in the art.

A digital two-dimensional inverse transform can be expressed as

$$f ( u , v ) = \frac{1}{NM} {\sum }_{n = 0}^{N - 1} {\sum }_{m = 0}^{M - 1} {B}^{- 1} ( u , v , n , m ) F ( n , m ) \qquad ( 1 )$$

where B(u,v,n,m) are the two-dimensional basis functions. If the basis functions are cosine functions, then equation (1) represents the decoding used in the JPEG and MPEG algorithms. Other basis functions are also possible e.g. Walsh, Haar, Sine, Slant etc. The described example displays utilise the Walsh transform, but suitable modifications can be made to demonstrate the process with other transforms. The one-dimensional Walsh transform basis functions are shown in FIG. 1.

These basis functions B(u,n) of FIG. 1 have the property that B(u,n)=B⁻¹(u,n), i.e. the basis functions for the inverse transform equal the basis functions for the forward transform. The two dimensional basis functions may be created by multiplying together two sets of one dimensional basis functions i.e. B(u,v,n,m)=B(u,n)B(v,m) and B⁻¹(u,v,n,m)=B⁻¹(u,n)B⁻¹(v,m). As the Walsh functions have only two values (1 and −1) the multiplication operation can be considered as a form of XOR operation.

Therefore the operation to be implemented in each pixel is:

$$f ( u , v ) = \frac{1}{NM} {\sum }_{m = 0}^{M - 1} {\sum }_{n = 0}^{N - 1} {B}^{- 1} ( u , n ) {B}^{- 1} ( v , m ) F ( n , m ) \qquad ( 2 )$$

Referring to FIG. 2, a display component 2 is shown having a plurality of blocks 4 of pixels 6. The pixels 6 are arranged as a regular matrix of rows 8 and columns 10 within each block. FIG. 2 illustrates blocks of sixty four pixels 6 arranged as eight rows 8 and eight columns 10, but as will be appreciated a different number of pixels for each block is also possible. The blocks 4 are likewise arranged as columns 12 and rows 14. At the perimeter of the display are arranged basis function generating circuitry 18 and block selection circuitry 20. The block selection circuitry 20 selects rows 8 of blocks via respective block select lines (not shown). Basis function generating circuitry 18 outputs basis functions for rows 8 of pixels on row basis function outputs 100 connected to pixel rows 8 along row basis function lines 102. The basis function generating circuitry 18 also outputs basis functions for columns of pixels 10 on column basis function outputs 104 connected to pixel columns through column basis function lines 106. For clarity, only one row 102 and one column 106 basis function lines are shown in FIG. 2, although the skilled person will appreciate that each pixel requires basis function inputs and accordingly each row and column of pixels will in the described embodiment be provided with its own row and column basis function lines respectively.

FIG. 3 illustrates the circuitry within each pixel 6. Current source 22 is connected through first switch 24 to a capacitance 26 connected in turn to ground 36. The current source is supplied from high voltage power rail 28. Likewise, current sink 32 is connected through second switch 34 to the same capacitance 26; the current sink is supplied from low voltage power rail 38. Both the current source 22 and current sink 32 can be modulated to control the output current based on an input signal 30. Control circuitry 40 is provided to control the first and second switches in accordance with signals received on column basis function input 42 connected to column basis function line 106 and row basis function input 44 connected to row basis function line 102.

These are combined with XOR gate 46 which controls the second switch 34 directly and the first switch through inverter 48.

This pixel circuit implements equation (2) as will now be explained.

Herein liquid crystal is considered to have a constant capacitance C charged by a current I wherein:

$$I = C \frac{ⅆ V}{ⅆ t} \qquad ( 3 )$$

Integrating this with the initial condition that V(0)=0 and dividing I(t) into a series of constant currents I(n) gives us

$$V ( N Δ t ) = \frac{Δ t}{C} {\sum }_{n = 0}^{N - 1} I ( n ) \qquad ( 4 )$$

where Δt is the interval between different currents. Now consider several pixels indexed by u. The voltage in each of the pixels can then be written as

$$V ( u , N Δ t ) = \frac{Δ t}{C} {\sum }_{n = 0}^{N - 1} I ( u , n )$$

Then if the currents are gated by a switch B(n) and there are switches in each of the pixels denoted by index u we write the currents present in all pixels as I(u,n)=B(u,n)I(n) i.e. current I(n) is present in all pixels indexed by u and can therefore be seen to represent a transform coefficient if B(u,n) are the basis functions of a transform i.e.

$$V ( u , N Δ t ) = \frac{Δ t}{C} {\sum }_{n = 0}^{N - 1} B ( u , n ) I ( n ) \qquad ( 5 )$$

This is a one dimensional transform, the two dimensional transform is achieved by introducing more switches so that

$$\begin{matrix}V ( u , v , NM Δ t ) = \frac{Δ t}{C} {\sum }_{m = 0}^{M - 1} {\sum }_{n = 0}^{N - 1} B ( u , n ) B ( v , m ) I ( n , m ) \\ = \frac{Δ t}{C} {\sum }_{m = 0}^{M - 1} {\sum }_{n = 0}^{N - 1} {B}^{- 1} ( u , n ) {B}^{- 1} ( v , m ) I ( n , m )\end{matrix} \qquad ( 6 )$$

which is our required transform.

The pixel circuit to achieve this operation uses current sources and sinks in the pixel and a number of basis function switches. The basis function product B⁻¹(u,n).B⁻¹(v,m) has values of ±1, to implement this requires two switches 24, 34 (one to allow current to flow onto the pixel capacitance and one to allow current to flow off of the pixel capacitance) and further logic in the form of the XOR gate 46 and the inverter 48 to obtain the two-dimensional implementation.

In use, a sequence of data coded by a transform using basis functions is provided to display component 2. Data for each block 4 is provided sequentially, and block selection circuitry 20 selects the corresponding block in turn.

The data for each block includes a sequence of data elements. These are used to modulate in parallel all of the current sources and sinks of the pixels of the block. Thus, each pixel receives the same input data in parallel.

The basis function values are calculated by basis function generating circuitry 18 which generates a series of column basis functions and row basis functions and outputs them along column basis function lines 104 to the column basis function inputs 42 to each pixel of a column 12 and along row basis function lines 102 to row basis function inputs 44 to each pixel of a row 14.

A new basis function value is required for each new element of input data, and the basis function generating circuitry 18 is therefore arranged to supply a sequence of basis function values synchronously with the elements of the input data stream. One of the row basis function values and the column basis function values changes for every new data element, whereas the other of the row basis function values and the column basis function values changes only every N data elements, where N is the integer number of rows or columns in the block. Thus, in the example shown of a block 4 with 8 rows 8 and 8 columns 10 of pixels 6, the row basis function values may be changed for every new data element in the input data stream and the column basis function values only every eight data elements of the input data stream.

Over time, each different row 8 of pixels in a block 4 is supplied with different basis function inputs. Likewise, each column 10 is supplied with different basis function inputs.

The basis function values are combined in each pixel by the XOR gate and inverter which together deliver the required multiplication using the Walsh transform with values of +1 or −1 to deliver a sequence of basis function values unique to each pixel within the block. Since one of the first 24 and second 34 switches needs to be driven inversely to the other, the second switch 34 is connected directly to the output of the XOR gate and the first switch 24 through inverter 48.

The capacitance 26 accumulates, and thus sums, the N×N (here 64) data elements multiplied by the basis function values and accordingly ends up with a charge representing the value of equation (6). Since this occurs in parallel for each pixel 4 of the selected block 2, the decoding is essentially taking place in parallel within the array.

The invention thus reduces the need for separate decoder circuitry and can therefore reduce the amount of data needed to be delivered between the decoder circuitry and the display. This has a number of benefits, especially to reduce power consumption and electromagnetic interference.

Although the above implementation describes the use of block select circuitry 20 to select individual blocks 4 sequentially it is also possible to decode the data in a number of blocks simultaneously and in parallel.

In the case that the display component 2 is the active plate of an active matrix LCD the capacitance may be the capacitance of a liquid crystal display (pixel) electrode. As is well known in the art, one or more capacitors may be provided in the pixel to increase the capacitance and the capacitance 26 may include such further capacitors. As illustrated in FIG. 4, a complete LCD is formed by aligning a passive plate 50 in registration with active plate 2 and providing liquid crystal material 52 between the active plate 2 and passive plate 50. The display may be used, for example, in a mobile communications device.

In alternative embodiments the display component may be an AMPLED (active matrix polymer light emitting diode display) or other active matrix organic light emitting diode display (AMOLED), the capacitance 22 may simply be a capacitor, and the output of each light emitting diode may be controlled by a circuit dependent on the voltage on the capacitor. The skilled person will be familiar with how to control a LED based on a voltage, here the voltage on the capacitance.

FIG. 5 illustrates an alternative pixel arrangement in which capacitance 26 is implemented by a thin film capacitor connected through drive circuitry 90 to a polymer light emitting diode 92 so that the display component is an active matrix polymer light emitting diode display. In a less preferred embodiment, the polymer light emitting diode may be replaced by another organic light emitting diode.

Regardless of display type, there are a number of ways of arranging for the input data stream to modulate each element of the block. A first example is illustrated in FIG. 6, which shows photodiodes 60 being used as current source 22 and current sink 32. These are addressed by an optical signal from light emitting diode (LED) 62 acting as modulator. Photodiodes 60 conduct when illuminated to ensure that the photodiodes 60 act as current source 22 and sink 32 when addressed.

A separate LED 62 may be provided behind each block 4 to address the block elements separately to enable blocks to be addressed in parallel. It should be noted that the LED can only generate positive data. However, the input data may take positive or negative values. This difficulty is resolved by testing the sign of the input data with comparator 64 and changing the sign of the basis functions output by basis function generator 20 in accordance with the output of the comparator 64. Since the required operation of equation (6) is multiplication, this preserves the output.

An alternative arrangement is illustrated in FIG. 7. Rows 8 of blocks 4 are selected by block selection circuitry 20 through row block selection lines 66. LEDs 62 are provided for each column 10 of blocks 4 through optical waveguides 68 arranged as a backlight. In this way, each block of a row 10 of blocks is decoded in parallel but different rows 10 of blocks are decoded one after the other.

An alternative embodiment is illustrated in FIG. 8 which uses electrical rather than optical addressing. The current source 22 and sink 32 are in this embodiment complementary n-type 70 and p-type 72 FETs, with the sources 76 and drains 78 connected in series with the switches 24, 34 and the control terminals 74, i.e. the gates, connected through common data lines 96 to receive the input data from modulator 94.

The source and sink can only supply positive current so again the sign of the input data is monitored and the basis function values output by the basis function generator 20 are reversed in sign when the input data is negative. FIG. 9 illustrates a detailed implementation of the circuit of FIG. 8. The XOR gate 46 and inverter 48 are implemented by control circuitry 40, FETs T1, T2, T3 and T4, and first and second switches by FETs T5 and T6.

FIG. 9 illustrates two further points. FET T7 is used as a reset switch 80, connected between the capacitor 26 and low voltage rail 38, with its gate connected to high voltage rail 28. To reset the display, the low voltage rail 38 is brought to ground and high voltage rail 28 brought low to switch on transistor T7 to reset the charge on the capacitor.

Further, FET T8 is used as block select switch 82, connected between capacitor 26 and the rest of the pixel circuitry. It is controlled by block select line 66, to allow the capacitance 26 to be charged only when the switch 82 is on.

From reading the present disclosure, other variations and modifications will be apparent to persons skilled in the art. Such variations and modifications may involve equivalent and other features which are already known in the design, manufacture and use of displays and which may be used in addition to or instead of features described herein.

1. A display component, for decoding and displaying data coded using a transform having basis functions; comprising:
a plurality of pixels arranged as a block;
each pixel including:
a summing element);
an first element providing a unit positive contribution to the summing element;
a first switch connecting the first element to the summing element;
a second element providing a unit negative contribution to the summing element;
a second switch connecting the second element to the summing element;
control circuitry connected to the first and second switches for switching the first and second switches in accordance with basis function values;
the display component further comprising a modulator for modulating all the first and second elements of the pixels of a block in common in accordance with input data, so that the summing element accumulates decoded input data for display in accordance with the input data and the basis function values.

2. A display component according to claim 1, wherein:
the summing element is a capacitance, the voltage on the capacitance determining the pixel output;
the first element is a modulated current source for charging the capacitance, and
the second element is a modulated current sink for discharging the capacitance.

3. A display component according to claim 2 wherein the current source is a photodiode connected between a high voltage rail and the capacitance, the current sink is a photodiode connected between a low voltage rail and the capacitance, and the modulator includes a light emitting element arranged to transmit an optical signal to the photodiodes of the block to modulate the photodiodes.

4. A display component according to claim 2 wherein the current sources and sinks are transistors having control terminals connected through common data lines to the modulator.

5. A display component according to claim 1 comprising:
a plurality of the blocks are arranged in rows and columns, each row of blocks having a block select line for selecting that row of blocks;
wherein the pixel elements of each row of blocks only operate to decode data when selected by the block select line.

6. A display component according to claim 5 wherein the pixels comprise a block select switch connected between the summing element (26) and the first and second switches the control input of the block select switch (82) being connected to the block select line.

7. A display component according to claim 1 wherein:
the control circuitry of each pixel has row and column basis function inputs;
further comprising:
row basis function lines connected to the row basis function input of each pixel element of a row of pixel elements of a block; and
column basis function lines connected to the column basis function input of each pixel element of a column of pixel elements of a block; and
wherein the at least one basis function generator generates basis functions for each row and column and outputs the basis functions on respective outputs, connected to respective row and column basis function lines.

8. A display component according to claim 7 wherein the control circuitry has an XOR gate having the XOR gate inputs connected to the row and column basis function inputs and the XOR gate output connected to one of the first and second switches directly and the other of the first and second switches through an inverter.

9. A display component according to claim 1 wherein the basis functions are Walsh basis functions.

10. A liquid crystal display, comprising an active plate in the form of a display component according to claim 1, a passive plate, and liquid crystal (52) between the active and passive plates.

11. A display component according to claim 1 wherein each pixel element further includes a polymer light emitting diode for emitting light in accordance with the decoded input data on the summing element.

12. A method of driving a display having a plurality of a plurality of pixels arranged as a block, each pixel including a summing element a first element providing a unit positive contribution to the summing element; a second element providing a unit negative contribution to the summing element; and switches connecting the first and second elements to the summing element, the method including:
accepting an input data stream for the block including a plurality of sequential data items coded using a transform having basis functions;
modulating the first and second elements in common for all pixels of the block in accordance with the input data stream;
switching the switches in each pixel between a state in which the first and second elements are connected to the summing element to add to or subtract from the data accumulated on the summing element and a state in which the first and second element are not connected, the switching taking place sequentially in accordance with a sequence of basis function values for each pixel of the block determined by the location of each pixel within the block; and displaying a visual output for each pixel in accordance with the data accumulated on the summing element.
